(19) United States
(12) Patent Application Publication
(10) Pub. No.: US 2006/0045285 A1
(43) Pub. Date: Mar. 2, 2006

(54) Headphones

(76) Inventor: Jens Bremermann, Stuhr (DE)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/147,504

(22) Filed: Jun. 8, 2005

(30) Foreign Application Priority Data
Jun. 8, 2004 (DE) 10 2004 027 803.2

(51) Int. Cl. H04R 5/02; H04R 5/00; H04R 1/10

(52) U.S. Cl. 381/74; 381/309; 381/26

(57) ABSTRACT

The invention relates to a pair of headphones or a headset comprising a first and a second sound transducer for reproducing a useful signal, wherein the useful signal is reproduced using the first or second sound transducer.

### CROSS-REFERENCE TO RELATED APPLICATION

This application claims priority of German Application No. 10 2004 027 803.2 filed Jun. 8, 2004, the complete disclosure of which is hereby incorporated by reference.

### BACKGROUND OF THE INVENTION

a) Field of the Invention

The invention relates to a pair of headphones and a headset.

b) Description of the Related Art

Headphones and headsets are known from DE 198 18 925, DE 199 26 552, U.S. Pat. No. 6,058,194, EP 0 869 696, EP 0 801 785, WO 98/45937 and WO 02/07477.

Headphones with active noise suppression (or “sound isolation”, or “sound cancellation” or “noise compensation”) have been sold by several companies for some considerable time, including by Sennheiser, who sell such equipment under the “NoiseGard” trademark. In such headphones, which include an ear cup for the left ear and an ear cup for the right-hand system for the right ear, each ear cup containing a sound reproduction system or a sound transducer, interfering sound is sensed by microphones on the outside of one ear cup or by means of microphones inside the ear cup, and reproduced using appropriate electronic circuitry such that the real interference and the reproduced interference are superimposed on each other, with the effect that perception of the interference is dramatically reduced overall. Such systems are already widespread in the military field, and in aircraft. In the latter fields, such headphones are not only suitable for sound reproduction, but are also used as active noise suppression devices. In addition, they also have a useful signal input and are often fitted with microphones so that the person wearing such headphones can also be in voice communication with other participants. Supplying the useful signals to both sound reproduction systems and simultaneously suppressing interference as far as possible on both sides enables excellent clarity of sound, and the wearer of the headphones has maximum possible “wearing comfort”.

### OBJECT AND SUMMARY OF THE INVENTION

The primary object of the present invention is to provide binaural headphones that can also be used in road traffic.

This object is achieved with headphones comprising a first and a second sound transducer for reproducing a useful signal wherein the useful signal is reproduced in a first operating mode using only one of the two sound transducers.

The invention further comprises a headset having a first and second sound transducer for reproducing a useful signal, wherein the useful signal is reproduced in a first operating mode using only one of the two sound transducers.

The invention proposes that the useful or wanted signal be supplied not to both sound reproduction systems of the headphones, but to only one of said systems, namely to the right reproduction system or to the left reproduction system of the headphones, but in any case not to both sound reproduction systems simultaneously. The invention is based on the idea of reproducing the useful signal monaurally in a pair of headphones or a headset having two sound transducers.

The advantage of the solution according to the invention consists, in particular, in the headphones of the invention also being suitable, as a result of monaural sound reproduction, for being used by a road traffic participant. It has been forbidden until now to use headphones with active noise suppression in road traffic (be it by motorists, truck drivers or cyclists, etc.), if the latter persons hear useful or wanted signals, e.g. from a radio, a walkman or other sound medium binaurally through the headphones, because there is a risk then that such traffic participants can no longer hear warning signals from emergency services, in other words signals from emergency services such as ambulances, police cars, fire tenders, etc.

This is possible with the invention, in contrast, because by supplying the useful signal to one ear only, it is still possible to hear the entire acoustics of the entire surroundings with the ear that is not exposed to sound from the sound source, thus ensuring maximum possible attention and traffic safety.

Binaural headsets or headphones can thus be used monaurally in road traffic, with the “free ear” continuing to hear ambient sounds and meet the requirements of road traffic regulations.

### BRIEF DESCRIPTION OF THE DRAWINGS

In the drawings:

FIG. 1 shows a schematic view of a headset according to a first embodiment;

FIG. 2 shows a schematic view of a headset according to a second embodiment;

FIG. 3 shows a schematic view of a headset according to a third embodiment;

FIG. 4 shows a schematic view of a headset according to a further embodiment;

FIG. 5 shows a schematic view of a sound reproduction system;

FIG. 6 shows a schematic view of a further sound reproduction system; and

FIG. 7 shows a schematic view of a pair of headphones according to a further embodiment.

### DESCRIPTION OF THE PREFERRED EMBODIMENTS

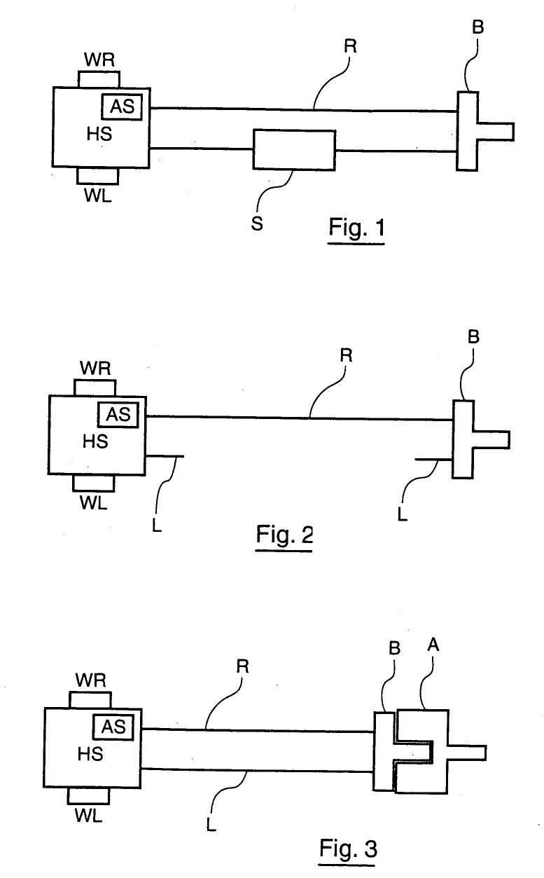

FIG. 1 shows a schematic view of a headset according to a first embodiment of the invention. This Figure shows a headset HS having two sound transducers WR, WL, a supply line for useful signals L, R, and a standard socket B. The supply line for the useful signals has at least two cores, i.e. one core L for the left sound transducer WL and one core R for the right sound transducer WR. A switching device S is provided in supply line L for the left sound transducer WL of headset HS. By means of said switch S, the useful signal to the left sound transducer WL can be disconnected if so required. To do this, it is necessary to perform a mechanical operation on the supply line to the headset. Depending on the state of switch S, the useful signal is outputted to the right sound transducer WR only, or to both sound transducers WL, WR. Alternatively, switch S can also be mounted in the immediate vicinity of the left sound transducer WL, with the result that no mechanical operation need be performed on the supply line to the headset. This means that a headset or pair of headphones according to the first embodiment can be used in both ways, either binaurally or just monaurally. The specific way that the headset is used can be adapted to the restrictions on use that apply, for example as the driver of a vehicle, or at particular workplaces. However, a headset of this kind is likewise suitable for being used binaurally in situations that are not subject to restrictions, such as in the front passenger seat of a vehicle.

FIG. 2 shows a schematic view of a headset HS according to a second embodiment. As in the first embodiment, a headset HS with two sound transducers WL, WR, a supply line R and a standard socket B is provided. Said headset HS is a binaural headset, i.e. one with two sound transducers WL, WR. However, core L for the left sound transducer WL is not connected to socket B, and the supply line to the left sound transducer WL is permanently disconnected. Only monaural reproduction of the useful signals is possible, therefore.

FIG. 3 shows a schematic view of a headset HS according to a third embodiment of the invention. Here, a headset HS with two sound transducers, supply lines L, R for the left and right sound transducers WL, WR of headset HS, and a suitable socket B are provided. An adapter A that can be plugged into socket B is also shown. The purpose of said adapter or plug adapter A is to separate the useful signal from binaural reproduction to monaural reproduction, meaning that when an adapter A is present or inserted, only monaural reproduction is possible with the binaural headset. Removing the adapter cancels the separation of useful signals, and the useful signal can be reproduced binaurally again by the headset. Adapter A can be configured in such a way, for example, that a stereo plug connector at one end is converted to a mono socket at the other.

Another option is for the headset to include an active noise suppression unit AS for suppressing, isolating, cancelling or reducing external sounds.

Even though it is described in the above embodiments that supply line L for the left sound transducer WL of headset HS is interrupted or disconnected, an alternative way of doing this, of course, is with supply line R for the right sound transducer WR.

The invention is therefore based on the idea of ensuring that one of the two channels for reproducing the useful signal in a headset is available, by means of either a switch on the headset or in the cable, an adapter at the interface to the source of the useful signal, or by separating or omitting the connection to the useful signal.

In addition to use in road traffic, the headphones or headset described above can also be used by other persons in charge of vehicles, such as aircraft pilots, air traffic controllers, etc. Likewise, useful signals alien to the aircraft or workplace can thus be outputted monaurally in a headset or pair of headphones designed for binaural sound reproduction. Such alien signals can be telephone signals, audio signals or the like.

Monaural or single-channel reproduction of useful signals in headphones or headsets with two sound transducers for binaural reproduction can be achieved by providing a switch on the headphones or on the headset or in the respective cable. By means of said switch, the user can toggle between monaural and binaural sound reproduction. The changeover from one to the other can be manual or automatic.

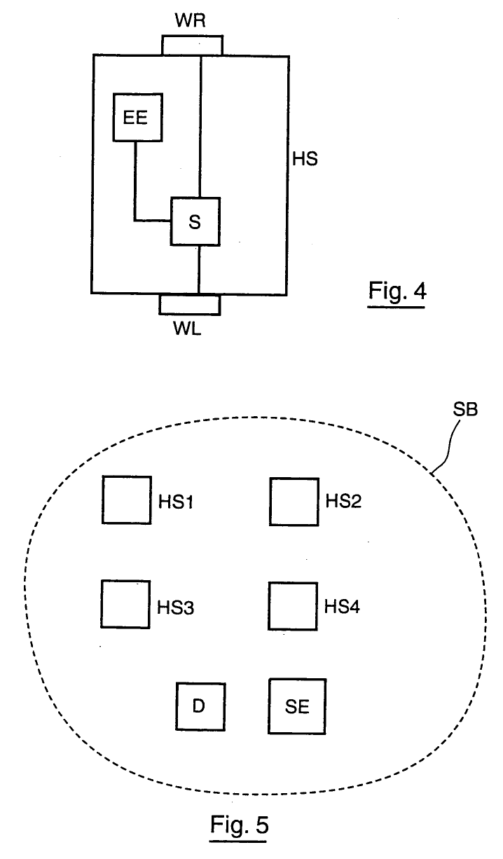

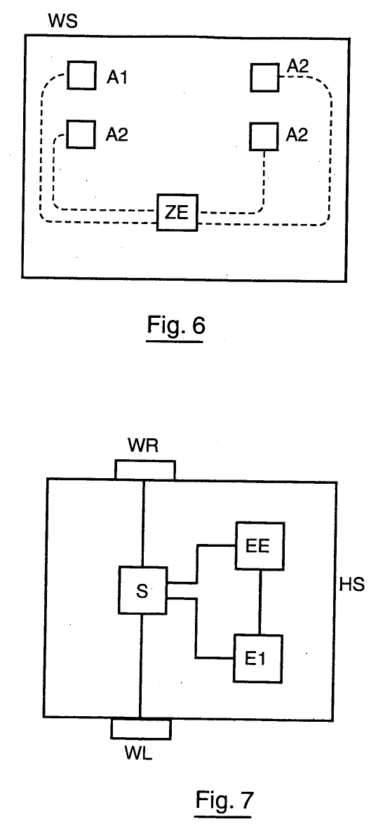

Although a wired headphone set or headset was shown in the embodiments above, the basic idea of the invention can be realized with wireless headphones according to FIG. 4 (and pursuant to FIGS. 1 to 3). A set of wireless headphones with a wireless receiver unit EE is thus provided, said headphones having two sound transducers WL, WR, the useful signal being reproduced in a first operating mode with only one of the two sound transducers, whereas in a second operating mode the useful signal is reproduced with both sound transducers.

A means for switching into the first operating mode (monaural reproduction) can be implemented in the form of an adapter, a plug adapter or a switch, i.e. a switch unit S. The plug, switch or adapter can be disposed in or on a cable hoop in the headphones, or in the connection between an electronics unit and the transducer. Alternatively, a dongle can be provided that, when inserted into or onto the headphones, switches the operating mode from the first, i.e. reproduction through only one sound transducer, to a second operating mode, i.e. reproduction through both sound transducers, or vice versa. On insertion of the dongle, the operating mode can be changed by software or by mechanical cut-in or cut-out.

Alternatively, or in addition to the above examples, switching between the first and the second operating mode can be initialized in the transfer protocol of the wireless headphones (as, for example, in the Bluetooth protocol or in Bluetooth software). The changeover can be performed by a mechanical switch or by a software setting on the wireless headphones, or in the wireless transmitter. For example, a certain set of wireless headphones can be switched to the first operating mode (reproduction through only one of the two sound transducers). Another set of wireless headphones in the vicinity can be operated in the second operating mode (reproduction through both sound transducers), in contrast.

FIG. 5 shows a schematic view of a sound reproduction system. Detection devices D for sensing the positions of wireless headphone sets can be additionally disposed within the transmission range SB of wireless transmitter SE. From the position of a wireless headphone set, it is possible to detect whether the wearer of the wireless headphones is in an area where reproduction of a useful signal through both sound transducers is undesired or not allowed. A set of wireless headphones such as headphones HS4 can then be switched automatically to the first operating mode (reproduction through only one of the sound transducers) when the headset/headphones is/are in an area where reproduction through one sound transducer is desired or necessary. This enables wireless headphones to be used in a car, for example, so that when one of the persons wearing the wireless headphones sits down in the driver's seat, his headphones can be switched from a second operating mode (reproduction through two sound transducers) to a first operating mode (reproduction through only one sound transducer), or a first operating mode can be activated. In this way, it is possible to ensure that the driver can use a set of wireless headphones or a wireless headset in a vehicle, but such that the useful signal is only reproduced on one of the two sound transducers. Thus, the same set of wireless headphones or headset can be used by the driver or by the passengers.

According to a further embodiment of the invention, one of the sound transducers can be configured as a clip-on, such that one of the sound transducers can be removed when so required, and the useful signal can be reproduced through the remaining sound transducer only. If so required, the headphones or headset can include temple pads to make the headphones or headset comfortable to wear when one of the sound transducers has been removed. The removable transducer preferably has an electrical audio interface so that the transducer can be used to reproduce the useful signal when the transducer is clipped onto the headphones or headset.

Operating the headphones or headset in a first operating mode (reproduction through only one sound transducer) and in a second operating mode (reproduction through both sound transducers) enables the headphones or headset to be used by the driver and by passengers, which means that the same headphones/headsets are versatile in use.

The wireless headphones can preferably be fitted with a unit for active suppression of external noise, wherein said unit for active noise suppression can co-operate with one or both sound transducers. According to a further embodiment of the invention, a plurality of connection points A1, A2 for headphones or headsets can be fitted in a vehicle, for example, in order to supply the useful signal and to provide a rear-sear entertainment system. The connection points can be connected to a central unit ZE, wherein said central unit ZE controls the changeovers between the first and second operating modes for said connection points. The headphones/headsets of the persons travelling in the vehicle can be supplied with a useful signal via these connection points. However, the connection for the driver's headphones or headset is preferably configured so that operation is possible only in the first operating mode (reproduction through only one of the two sound transducers). The connections for the passenger headphones are configured so that the useful signal can be reproduced in a second operating mode (reproduction through both sound transducers). Alternatively, the useful signal can be supplied in combination with a further signal, also via the connection points. The additional signal can be superimposed on the useful signal or coded within the useful signal. The headphones/headset must then include a unit E1 which can sense the additional signal and, on the basis of said signal, can control the switch unit for switching between the first and second operating mode.

The useful signal described above is preferably an audio signal.

While the foregoing description and drawings represent the present invention, it will be obvious to those skilled in the art that various changes may be made therein without departing from the true spirit and scope of the present invention.

1-12. (canceled)

13. Headphones, comprising:
a first and a second sound transducer for reproducing a useful signal;
said useful signal being reproduced in a first operating mode using only one of the two sound transducers.

14. Headphones according to claim 13, including a switch unit for switching reproduction of the useful signal in the first operating mode, by reproducing the useful signal using one of the two sound transducers, to reproduction in a second operating mode, wherein the useful signal is reproduced in the second operating mode by both sound transducers.

15. Headphones according to claim 13, including active suppression of external noise, wherein the unit for active noise suppression is configured to act upon at least one of the first and second sound transducers.

16. Headphones according to claim 13, wherein the headphones are configured as wireless headphones with a wireless receiver unit.

17. Headphones according to claim 16, wherein the switch unit switches from the first to the second operating mode, or vice versa, depending on the signals received by the wireless receiver unit.

18. A headset, comprising:
a first and a second sound transducer for reproducing a useful signal;
wherein the useful signal is reproduced in a first operating mode using only one of the two sound transducers.

19. The headset according to claim 18, including a switch unit for switching reproduction of the useful signal in the first operating mode, by reproducing the useful signal using one of the two sound transducers, to reproduction in a second operating mode, wherein the useful signal is reproduced in the second operating mode by both sound transducers.

20. The headset according to claim 18, including active suppression of external noise, wherein the unit for active noise suppression is configured to act upon at least one of the first and second sound transducers.

21. The headset according to claim 18, wherein the headset is configured as a wireless headset with a wireless receiver unit.

22. The headset according to claim 21, wherein the switch unit switches from the first to the second operating mode, or vice versa, depending on the signals received by the wireless receiver unit.

23. A sound reproduction system for audio signals, comprising:
a first connection point for a pair of headphones with two sound transducers, for supplying a useful signal in such a way that the useful signal is reproduced in a first operating mode on only one of the two sound transducers of the headphones.

24. The sound reproduction system according to claim 23, comprising at least one second connection point for a pair of headphones with two sound transducers, for supplying a useful signal in such a way that the useful signal is reproduced in a second operating mode on both the sound transducers of the headphones.
